(19) United States
(12) Patent Application Publication
(10) Pub. No.: US 2018/0352499 A1
(43) Pub. Date: Dec. 6, 2018

(54) SELECTIVE WLAN PROCESSING BASED ON PREAMBLE INFORMATION

(71) Applicant: Ruckus Wireless, Inc., Sunnyvale, CA (US)

(72) Inventors: Peter Khoury, San Francisco, CA (US); Sundar Sankaran, Saratoga, CA (US); Sandip C. Patel, San Jose, CA (US)

(21) Appl. No.: 15/775,548

(22) PCT Filed: Dec. 31, 2015
(86) PCT No.: PCT/US2015/068347

§ 371 Date: May 11, 2018

Related U.S. Application Data
(60) Provisional application No. 62/253,687, filed on Nov. 11, 2015.

(51) Int. Cl. H04W 48/08; H04L 29/06; H04W 72/04

(52) U.S. Cl. CPC H04W 48/08; H04W 84/12; H04W 72/0446; H04L 69/08

(57) ABSTRACT

A communication technique for conveying configuration information in a preamble in a frame is described. In this communication technique, an access point may receive a frame from a transmitting electronic device in a wireless local area network (WLAN) with media-access-control (MAC) information in a preamble and at least a packet as a payload. The MAC information may be communicated from a MAC layer to a physical layer in an interface circuit in the access point. Moreover, the MAC information may include an identifier of the receiving electronic device. Based on the identifier, the access point may select a receive antenna pattern for use when receiving the payload.

### BACKGROUND

### Field

The described embodiments relate to techniques for communicating information among electronic devices, including selective processing of packets during wireless communication via a wireless local area network.

### Related Art

Many electronic devices are capable of wirelessly communicating with other electronic devices. For example, these electronic devices can include a networking subsystem that implements a network interface for: a cellular network (UMTS, LTE, etc.), a wireless local area network or WLAN (e.g., a wireless network such as described in the Institute of Electrical and Electronics Engineers (IEEE) 802.11 standard or Bluetooth from the Bluetooth Special Interest Group of Kirkland, Wash.), and/or another type of wireless network.

In order to facilitate wireless communication, electronic devices are often configured during many of these communication protocols. For example, a frame transmitted by a transmitting electronic device in a WLAN may include a preamble with configuration information (such as automatic-gain-control information and/or modulation-and-coding information) in configuration information fields that is used by a receiving electronic device to configure a receiver in the networking subsystem so that it can properly receive the payload in the frame (such as a packet). In particular, the configuration information in the preamble is usually communicated at a low data rate. Moreover, because the configuration information is in the preamble, it comes early in the transmission of the packet so that the receiver can use the configuration information to effectively process the packet, thereby improving the communication performance.

While the configuration information fields in the preamble are typically useful to all the electronic devices in the WLAN, the configuration information can vary significantly in different communication protocols or different versions of a communication protocol. Moreover, while generic configuration information in the preamble is often the same for the receiving electronic devices, the use of generic configuration information can constrain the adaptation or configuration of the receiving electronic devices, which may constitute an opportunity cost in the communication performance.

### SUMMARY

The described embodiments relate to a transmitting electronic device in a WLAN that communicates with an access point. This access point includes: an antenna connector (which may be connected to an antenna) and an interface circuit that communicates with the transmitting electronic device. During operation, a physical layer in the interface circuit receives a frame from the transmitting electronic device. This frame includes a preamble with an identifier of the transmitting electronic device. Then, the physical layer selects a receive antenna pattern for the antenna based on the identifier of the transmitting electronic device. Next, the physical layer may receive a packet as a payload in the frame.

Note that the identifier of the transmitting electronic device may include a MAC address of the transmitting electronic device. Moreover, the identifier of the transmitting electronic device may be a partial identifier or a full identifier of the transmitting electronic device.

Furthermore, the preamble may include a deferment duration interval. The deferment duration interval may be encoded as a fraction of a maximum deferment time (such as the network allocation vector). Additionally, the deferment duration may specify a minimum upper bound on the deferment time.

Note that the access point may include information in a broadcast message to one or more receiving electronic devices that specifies a maximum deferment duration interval.

In some embodiments, the access point delays transmitting another frame based on the deferment duration interval. This may increase the throughput in the WLAN.

Moreover, the WLAN may use an Institute of Electrical and Electronics Engineers (IEEE) 802.11 communication protocol.

Another embodiment provides the transmitting electronic device.

Another embodiment provides a computer-program product for use with the access point and/or the transmitting electronic device. This computer-program product includes instructions for at least some of the operations performed by the access point and/or the transmitting electronic device.

Another embodiment provides a method. This method includes at least some of the operations performed by the access point and/or the transmitting electronic device.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating electronic devices wirelessly communicating in accordance with an embodiment of the present disclosure.

FIG. 2 is a flow diagram illustrating a method for communicating preamble configuration information between an access point and a receiving electronic device in accordance with an embodiment of the present disclosure.

FIG. 3 is a drawing illustrating communication among the electronic devices in FIG. 1 in accordance with an embodiment of the present disclosure.

FIG. 4 is a flow diagram illustrating a method for communicating preamble configuration information between a transmitting electronic device and an access point in accordance with an embodiment of the present disclosure.

FIG. 5 is a drawing illustrating communication among the electronic devices in FIG. 1 in accordance with an embodiment of the present disclosure.

FIG. 6 is a drawing illustrating a frame format during communication among the electronic devices in FIG. 1 in accordance with an embodiment of the present disclosure.

FIG. 7 is a block diagram illustrating an electronic device in accordance with an embodiment of the present disclosure.

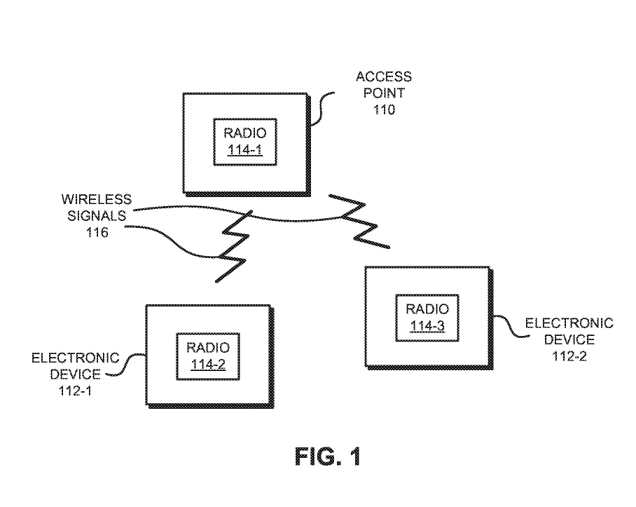

Table provides an embodiment of a preamble in a frame during communication among the electronic devices in FIG. 1.

Note that like reference numerals refer to corresponding parts throughout the drawings. Moreover, multiple instances of the same part are designated by a common prefix separated from an instance number by a dash.

### DETAILED DESCRIPTION

A communication technique for conveying configuration information in a preamble in a frame is described. In this communication technique, an access point may receive a frame from a transmitting electronic device in a wireless local area network (WLAN) with media-access-control (MAC) information in a preamble and at least a packet as a payload. The MAC information may be communicated from a MAC layer to a physical layer in an interface circuit in the access point. Moreover, the MAC information may include an identifier of the receiving electronic device. Based on the identifier, the access point may select a receive antenna pattern for use when receiving the payload

In this uplink embodiment, the communication technique may facilitate improved communication performance. By facilitating communication, the communication technique may increase customer satisfaction and loyalty.

In the discussion that follows, the access point and/or an electronic device (such as the transmitting electronic device or the receiving electronic device) may include a radio that communicates frames with packets in accordance with a communication protocol, such as an Institute of Electrical and Electronics Engineers (IEEE) 802.11 standard (which is sometimes referred to as ‘Wi-Fi,’ from the Wi-Fi Alliance of Austin, Tex.), Bluetooth (from the Bluetooth Special Interest Group of Kirkland, Wash.), and/or another type of wireless interface. In the discussion that follows, Wi-Fi is used as an illustrative example. However, a wide variety of communication protocols may be used.

Communication among electronic devices is shown in FIG. 1, which presents a block diagram illustrating access point 110 and electronic devices 112 (such as a portable electronic device, e.g., a cellular telephone or a smartphone) wirelessly communicating according to some embodiments. In particular, these electronic devices may wirelessly communicate while: transmitting advertising frames on wireless channels, detecting one another by scanning wireless channels, establishing connections (for example, by transmitting association requests), and/or transmitting and receiving frames (which may include the association requests and/or additional information as payloads).

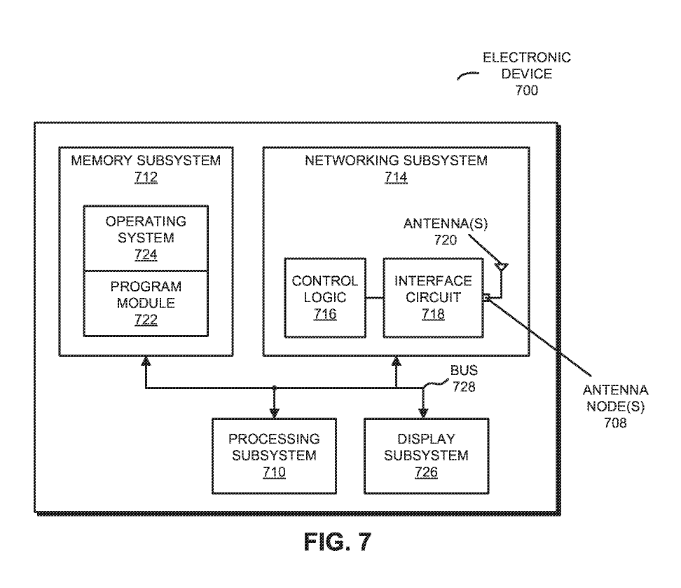

As described further below with reference to FIG. 7, access point 110 and electronic devices 112 may include subsystems, such as a networking subsystem, a memory subsystem and a processor subsystem. In addition, access point 110 and electronic devices 112 may include radios 114 in the networking subsystems. More generally, access point 110 and electronic devices 112 can include (or can be included within) any electronic devices with the networking subsystems that enable access point 110 and electronic devices 112 to wirelessly communicate with each other. This wireless communication can comprise transmitting advertisements on wireless channels to enable electronic devices to make initial contact or detect each other, followed by exchanging subsequent data/management frames (such as association requests and responses) to establish a connection, configure security options (e.g., Internet Protocol Security), transmit and receive frames with packets via the connection, etc. Note that while instances of radios 114 are shown in access point 110 and electronic devices 112, one or more of these instances may be different from the other instances of radios 114.

In FIG. 1, wireless signals 116 (represented by jagged lines) may be transmitted from radio 114-1 in access point 110. These wireless signals 116 may be received by radios 114 in electronic devices 112. In particular, access point 110 may transmit frames that include packets. In turn, these frames may be received by one or more of electronic devices 112. Consequently, access point 110 may transmit wireless signals 116 in a common channel during the wireless communication with electronic devices 112.

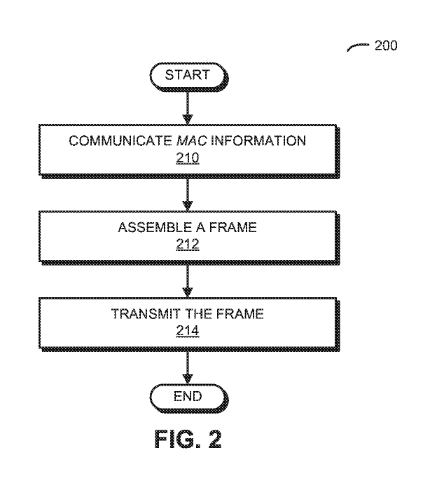

As described further below with reference to FIGS. 2, 3 and 6 and Table 1, in embodiments of the disclosed communication technique device-specific configuration information is included in a preamble in a given frame during the wireless communication between access point 110 and one of electronic devices 112 (such as electronic device 112-1). In particular, the preamble in the frame may include MAC information, such as an identifier of electronic device 112-1 (which, in this context, is sometimes referred to as ‘the receiving electronic device’) and/or a deferment duration interval. (However, in some embodiments the MAC information includes the deferment duration interval and excludes the identifier of electronic device 112-1.) For example, the identifier of electronic device 112-1 may include a MAC address of electronic device 112-1 (and, more generally, an association identifier of electronic device 112-1 or information that, directly or indirectly, specifies electronic device 112-1).

Moreover, the identifier of electronic device 112-1 may be a partial identifier or a full identifier of electronic device 112-1. Furthermore, the deferment duration interval may be encoded as a fraction of a maximum access-time deferment time (such as the network allocation vector or NAV). Note that the deferment duration may specify a maximum lower bound on the deferment time (which may equal the minimum upper bound on the deferment time).

This configuration information may allow electronic devices other than the intended recipient, which also use to WLAN, to save power by turning off their receivers after receiving the preamble and determining that the payload is intended for electronic device 112-1. In addition, electronic devices 112 may use the deferment duration interval to avoid premature transmissions while access point 110 is still communicating with electronic device 112-1. By avoiding excess deferment, electronic devices 112 can avoid unnecessary backoff periods. In particular, if the NAV time is more highly coded, it can be more reliably decoded and the estimates of the backoff time made by the electronic devices (including those that are far away) can be improved. Therefore, the communication technique may improve the throughput during the communication using the WLAN.

In some embodiments, the frame includes one or more packets that can be intended for one or more of electronic devices 112 (i.e., multicast communication). In these embodiments, the MAC information may also specify whether the one or more packets are all intended for electronic device 112-1 (i.e., whether the communication is unicast). If not, the other electronic devices 112 may not turn off their receivers when they receive the configuration information in the preamble of the frame. However, if the frame is a multicast frame, the identifier may specify a group of two or more of electronic devices 112 (i.e., a group identifier) instead of the identifier of electronic device 112-1.

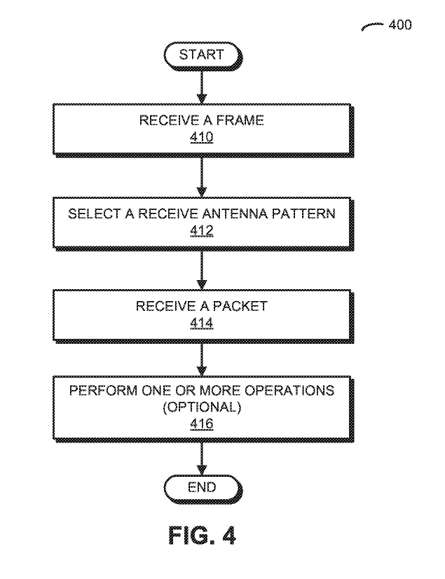

Alternatively or additionally, wireless signals 116 may be transmitted from radio 114-2 in electronic device 112-1. These wireless signals 116 may be received by radio 114-1 in access point 110. In particular, electronic device 112 may transmit frames that include packets. In turn, these frames may be received by access point 110. As described further below with reference to FIGS. 4-6 and Table 1, in embodiments of the disclosed communication technique the device-specific configuration information may be included in the preamble in a given frame during the wireless communication between one of electronic devices 112 (such as electronic device 112-1 and access point 110. In particular, the preamble may include the MAC information, such as the identifier of electronic device 112-1 (which, in this context, is sometimes referred to as ‘the transmitting electronic device’) and/or the deferment duration interval. However, in these uplink embodiments the deferment duration may specify a minimum upper bound on the deferment time.

The configuration information may allow a receiver in access point 110 to be dynamically configured while receiving the frame. In particular, based on the identifier that was received in the preamble, access point 110 may select a suitable receive antenna pattern for a set of antennas or for elements in an antenna (which are considered equivalent in the present discussion) that improves the communication performance while receiving the rest of the frame (such as one or more packets in a payload). This receive antenna pattern may be predetermined and stored in memory in access point 110. For example, access point 110 may have previously determined amplitudes or weights and phases for signals to the set of antennas in access point 110 that form the receive antenna pattern (such as via a matrix calculation that determines a steering vector). Alternatively or additionally, the receive antenna pattern may be adapted or changed using pattern shapers (such as reflectors) in an antenna or an antenna element in access point 110, which can be independently and selectively electrically coupled to ground to steer the antenna radiation pattern in different directions. Note that the receive antenna pattern may be characterized by a spatially varying intensity, with beams (or local maxima in the intensity) at certain locations or regions, and exclusion zones (with local minima in the intensity, e.g., locations or regions having an intensity less than a predefined value) at other locations or regions. In addition, access point 110 and electronic devices 112 may use the deferment duration interval to avoid premature transmissions while electronic device 112-1 is still communicating with access point 110. By avoiding collisions, access point 110 and electronic devices 112 can avoid unnecessary backoff periods. Therefore, the communication technique may improve the throughput during the communication using the WLAN.

In the described embodiments, processing a frame in access point 110 and/or electronic devices 112 includes: receiving wireless signals 116 with the frame; decoding/extracting the preamble and/or the packet from received wireless signals 116 to acquire the preamble and/or the packet; and processing the preamble and/or the packet to determine information contained in the preamble and/or the packet (such as the configuration information, feedback about the performance during the communication, etc.).

Note that the communication between access point 110 and electronic device 112-1 may be characterized by a variety of performance metrics, such as: a received signal strength (RSS), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving frames with packets.

We now further describe the downlink embodiments of the communication technique. FIG. 2 presents a flow diagram illustrating a method 200 for communicating preamble configuration information between an access point and a receiving electronic device in accordance with some embodiments. This method may be performed by an interface circuit in an access point (such as access point 110 in FIG. 1). During operation, aMAC layer in the interface circuit communicates MAC information (operation 210) to a physical layer in the interface circuit, where the MAC information includes an identifier of the receiving electronic device. (In the discussion that follows, the MAC layer or data link layer in an Open System Interconnection model includes hardware and/or firmware that transfers data between network entities and may detect and/or correct errors that occur in the physical layer, and the physical layer includes basic networking hardware transmission technologies for the WLAN.) Note that the identifier of the receiving electronic device may include aMAC address of the receiving electronic device. Moreover, the identifier of the receiving electronic device may be a partial identifier or a full identifier of the receiving electronic device. In some embodiments, the MAC information includes a deferment duration interval. The deferment duration interval may be encoded as a fraction of a maximum deferment time (such as the network allocation vector). Additionally, the deferment duration may specify a maximum lower bound on the deferment time.

Then, the physical layer assembles a frame (operation 212) that includes the MAC information in a preamble and at least a packet as a payload.

Next, the physical layer transmits the frame (operation 214) to the receiving electronic device. For example, the access point may transmit the frame to the receiving electronic device using an Institute of Electrical and Electronics Engineers (IEEE) 802.11 communication protocol.

In some embodiments, the MAC information in the preamble facilitates power saving in the receiving electronic device.

Moreover, the frame may include two or more packets and the MAC information may specify whether the two or more packets are all intended for the receiving electronic device.

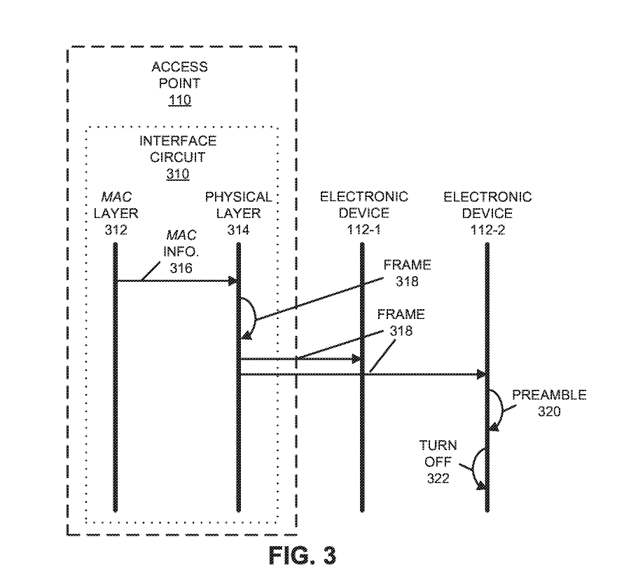

Embodiments of the communication technique are further illustrated in FIG. 3, which presents a drawing illustrating communication between access point 110, electronic device 112-1 and electronic device 112-2 in accordance with some embodiments. In particular, aMAC layer 312 in interface circuit 310 communicates MAC information 316 to a physical layer 314 in interface circuit 310, where MAC information 316 includes an identifier of electronic device 112-1 and/or a deferment duration interval.

Then, physical layer 314 assembles a frame 318 that includes MAC information 316 in a preamble and at least a packet as a payload. (However, in some embodiments there is no packet as a payload. For example, some of the packets have no data in them. These are so-called ‘null packets that can be used for sounding.)

Next, physical layer 314 transmits frame 318 to electronic device 112-1 and/or additional electronic devices (such as electronic device 112-2). After receiving preamble 320, electronic device 112-2 may use the identifier to determine that it is not the intended recipient of frame 318. Consequently, electronic device 112-2 may turn off 322 one or more receivers, e.g., for the deferment duration interval.

We now further describe the uplink embodiments of the communication technique. FIG. 4 presents a flow diagram illustrating a method 400 for communicating preamble configuration information between a transmitting electronic device and an access point in accordance with some embodiments. This method may be performed by an interface circuit in an access point (such as access point 110 in FIG. 1). During operation, a physical layer in the interface circuit receives a frame (operation 410) from the transmitting electronic device. This frame includes a preamble with an identifier of the transmitting electronic device and a deferment duration interval. Note that the identifier of the transmitting electronic device may include a MAC address of the transmitting electronic device. Moreover, the identifier of the transmitting electronic device may be a partial identifier or a full identifier of the transmitting electronic device. Furthermore, the deferment duration interval may be encoded as a fraction of a maximum deferment time (such as the network allocation vector). Additionally, the deferment duration may specify a minimum upper bound on the deferment time.

Then, the physical layer selects a receive antenna pattern (operation 412) for an antenna based on the identifier of the transmitting electronic device.

Next, the physical layer receives a packet (operation 414) as a payload in the frame.

In some embodiments, the access point and/or other electronic devices delay transmitting another frame based on the deferment duration interval. This may increase the throughput in the WLAN. Note that the access point may delay transmitting a frame if the frame being transmitted is not intended for the access point.

Moreover, the interface circuit may perform one or more optional operations (operation 416). For example, the interface circuit may broadcast a message to one or more receiving electronic devices that specifies a maximum deferment duration interval. (Note that a fraction (between zero and one) conveyed in the NAV may be a portion of this maximum deferment time.)

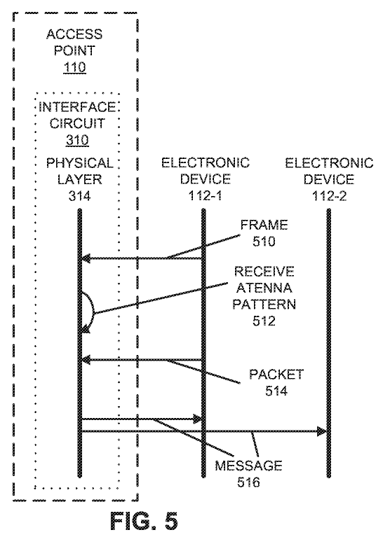

Embodiments of the communication technique are further illustrated in FIG. 5, which presents a drawing illustrating communication between access point 110, electronic device 112-1 and electronic device 112-2 in accordance with some embodiments. In particular, interface circuit 310 receives a frame 510 from electronic device 112-1. This frame includes the preamble with the identifier of electronic device 112-1 and the deferment duration interval.

Then, interface circuit 310 selects a receive antenna pattern 512 for an antenna based on the identifier of electronic device 112-1.

Next, interface circuit 310 receives a packet 514 as a payload in frame 510.

In some embodiments, access point 110 and/or other electronic devices (such as electronic device 112-2) delay transmitting another frame based on the deferment duration interval. This may increase the throughput in the WLAN. Alternatively or additionally, access point 110 and/or other electronic devices may delay reception to increase the battery life.

Moreover, interface circuit 310 may optionally broadcast a message 516 to electronic devices 112-1 and 112-2 that specifies an absolute deferment duration interval corresponding to a fraction (between zero and one) of the maximum deferment time.

In some embodiments of methods 200 and/or 400, there may be additional or fewer operations. For example, in some embodiments of method 200 the MAC information includes the deferment duration interval and excludes the identifier of the receiving electronic device. Moreover, the order of the operations may be changed, and/or two or more operations may be combined into a single operation.

In an exemplary embodiment, one or more additional fields are included in the preamble of a Wi-Fi frame, including a full or partial client identification number and a network access reservation time or bound. The preamble of a frame includes some information useful to all clients even those not being targeted by the transmission. Because the preamble is intended for all electronic devices, it is typically highly coded at a low data rate. (Note that the preamble may not only contain data useful to all the clients or the electronic devices. It may also contain data that must be received before a packet can be decoded. For example, this data may be received using an omni-directional antenna, even though the payload in the packet may only contain data that can be decoded using a directional antenna or antenna pattern.) Moreover, the preamble comes early in the transmission of the frame so that the receiving electronic device can use the information included in the preamble to effectively process the payload (such as one or more packets). The low coding means that either the preamble does not carry or convey much data or that it will consume a lot of airtime if it does carry a lot of data.

Typically, most of the data portion or payload of a frame is destined only for a particular client and therefore can be more lightly coded at a higher data rate. However, the information in this portion of the frame may not be receivable by all the electronic devices that can decode the preamble.

Typically, certain information is transmitted in the data portion. If this information were moved to the preamble it could enhance device and network performance. One piece of data is a partial or full identification of a client. Another piece of data is the network access time that allows a receiver to know how long the current transmitter intends to occupy the medium.

In some embodiments, the partial or full identification of a client is included in the preamble in both the uplink frames and the downlink frames. For an uplink frame this client identifier identifies or specifies the transmitter and in a downlink frame the client identifier identifies or specifies the receiver. This is because the access point-client relationship is a one-to-many relationship and the identifier included in the preamble may identify/distinguish the many not the one. Moreover, in some embodiments the preamble field contains a bit indicating whether the client-identifier field is the transmitter or the receiver (i.e., indicating whether the frame is an uplink or a downlink frame). Furthermore, in some embodiments in which there is a many-to-many transmission/association, the identifiers of the transmitter and the receiver are included in the preamble.

In the case of the uplink embodiments, the client identifier may be used to adjust or select a receive antenna pattern. In particular, different antenna patterns can selectively improve transmission and reception to electronic devices, but typically the antenna pattern that works well for one electronic device may not work well for another electronic device. Consequently, in order to take advantage of this technology, an access point may need to switch from one antenna pattern to another.

Currently, in random access media, an access point can change its transmitting antenna pattern. This can be done because the transmission is scheduled and the access point knows which electronic device is the target of the transmission. The scheduling and the transmission target knowledge typically allow the antenna pattern to be changed and switched before transmission.

However, in a random access protocol, it is usually very difficult to change the receive antenna pattern because at the start of reception, when the signal amplifier gain is set, the transmitter source is unknown. Moreover, changing the antenna pattern later during data packet reception, after the automatic-gain-control settling, affects the signal amplitude and phase. This may send the amplifier from a linear region into a saturated regime, thereby destroying the incoming signal quality. Furthermore, changing the signal phase during data-packet reception may affect baseband spatial filtering and decoding. Therefore, even though changing the antenna pattern in the middle of receiving a frame may theoretically aid the reception of a packet in the frame, in practice this often harms the receiver.

Some existing systems dynamically determine the receive antenna pattern for random access media while receiving a frame. However, these systems are often expensive because lots of complicated calculations need to be done in a very short period of time. Furthermore typically these systems are complicated because this solution usually requires access to the signal from all different antenna or beam patterns simultaneously. In contrast, the proposed communication technique may only require the selection of one antenna pattern at a given time, so the hardware requirements for the system may not be as demanding.

However, if the client identifier is included early enough in the preamble, the receiver can look up or use a selection technique to determine a beneficial antenna pattern to use to receive that particular transmitting electronic device. In order for this approach to work, the full or partial client identification may be placed in the highly coded preamble, so that the information can be decoded even when an omnidirectional (or other non-optimal) antenna pattern is used. Once the client-identifier information is decoded, the receive antenna pattern can be switched during the preamble, which is not as sensitive to changes as the data/payload portion of the frame because it is highly coded. Moreover, if the client-identifier information is placed early enough ahead of secondary training sequences used by the receiver, then the receive antenna pattern can be switched ahead of these training sequences and the automatic gain control can re-stabilize the amplitude and the phase can be re-estimated without losing any of the payload portion of the frame. (Consequently, in some embodiments the additional information in the preamble in the communication technique may be included prior to the information specifying the automatic-gain-control information and/or the modulation-and-coding information.)

Therefore, by including the client-identifier information early enough in the preamble, the extra training sequence later in the preamble may allow this approach to succeed. Moreover, because this approach does not require access to many multiple beam patterns simultaneously, it may offer a simpler and lower cost solution for improving the communication performance.

As noted previously, the destination MAC address is currently included in the MAC header of the packet contained in the payload portion of the frame. However, this MAC address cannot be used for selecting the receive antenna pattern. First, it is placed too late in the frame. By the time the MAC header is transmitted the receiving electronic device is already receiving the packet payload and cannot adjust its receive antenna pattern without saturating the amplifiers or messing up the receive filters. In addition, the MAC address in the payload is coded at the same rate as the payload. In order for the approach to show benefit, the client identifier may need to be received with an omnidirectional antenna, which is then switched to a receive antenna pattern with an improved beam to improve the payload reception.

The preamble may also include information specifying the network access time in order to facilitate fair network access. Currently, another field in the MAC header is the NAV or duration field. This field indicates the length of time that the client currently transmitting expects to occupy the medium. When another client receives this field, it is expected to defer transmission during this interval.

However, the NAV field suffers from the same issues as the client MAC address in the MAC header. It is entirely possible for a receiver to receive and correctly decode the preamble of an incoming packet, so that it knows that a valid Wi-Fi frame is being transmitted, but if the payload is lightly coded it may not be able to decode the MAC header and, thus, may be unable to know the value of the NAV included in the MAC header. Under these circumstances, the receiver must defer its transmission in a very conservative way by making a worst-case assumption about how long the transmitter may possibly be transmitting. The length of time that it defers for may be much longer than the time of the actual transmission. Because a client may continually receive packets that are not destined for it, and which it cannot fully decode and for which it must defer for excessive lengths of time, the throughput in a WLAN may be severely degrade.

By including information about the length of time the medium is busy in the more highly coded preamble, a receiver may defer for a more precise length of time. Therefore, if an electronic device receives a packet that is not intended for it and that it cannot decode, it can defer for a shorter period of time, which in turn gives it a better chance to gain access to the medium.

The NAV in the MAC header is typically incremented in units of microseconds and the period of time the transmitter may want to reserve the medium may extend up to many milliseconds. If this ratio of resolution to total duration is maintained, then 14 or 16 bits may need to be included in the preamble NAV field. Because the preamble is so heavily coded, including an additional 14 to 16 bits in it could consume a lot of transmission time and the amount of overhead that all these bits create could make the inclusion of the preamble NAV impractical (i.e., it may consume more resources, thereby hurting the throughput more than it would help). Consequently, even though the NAV can be defined in absolute units with a very tight resolution, it may be beneficial to define the preamble NAV in a different way.

In particular, as discussed above, an electronic device that receives and decodes a preamble without being able to decode a payload will have to defer for a very long time. If the communication technique can cut this amount of deferment time down at all, the change will be beneficial. Therefore, instead of defining the NAV time starting with a base unit of microseconds, in some embodiments the preamble NAV field is defined as a fraction of the largest time scale. The access point may broadcast information about the longest deferment time, so that the electronic devices connected to the WLAN know this base unit, and the preamble NAV time can be defined as fractions of this time.

For example a two-bit preamble NAV field could split the basic deferment time into four deferment time intervals. A 0,0 transferred in the preamble NAV may indicate a deferment time interval of one quarter of the maximum length, a 0,1 field value may indicate deferment of one half of the maximum length, a 1,0 field value may indicate three quarters and a 1,1 field value may indicate full deferment. The deferment time may also be exponentially based with a 1,1 field value indicating full deferment, a 1,0 field value indicating a one-half period deferment, a 0,1 field value indicating a one-quarter interval deferment, and a 0,0 field value indicating a one-eighth interval deferment. The later approach may allow for more gain if many of the frames and medium reservation periods in the WLAN are significantly smaller than the maximum length.

In order to allow for maximum flexibility, the access point may include in its broadcast message what the length of times should be for this WLAN for some or all of the possible preamble NAV combinations.

In the downlink case, the client identifier and/or the preamble NAV may facilitate power saving on mobile or portable electronic devices. When an electronic device is battery powered, it may want to turn off substantial portions of its receive circuitry in order to save power. Having both the full or partial client identifier along with an estimate of the length of time that the medium will be busy in the preamble may help the battery-powered electronic device save power for the right amount of time. If the electronic device turns off its receive circuitry for too long, it may miss a packet or frame that were intended for it. Alternatively, if the electronic device turns on the circuitry too soon, it will waste power.

Once the electronic device decodes the full or partial client identifier in the preamble, it knows whether it has to keep listening (full identification) or whether is likely that it should keep listening (partial identification). If the partial client identification does not match with the identifier of the electronic device, the electronic device can turn off its receivers and save power. However, the electronic device needs to know how long it should turn off the receivers. The preamble NAV may help the battery-powered electronic device determine the length of time it should remain powered down.

As described previously, the NAV may be defined absolutely and consume 14 to 16 bits of the preamble, but this amount of encoded information may outweigh the benefit. Alternatively, the preamble NAV may be defined as a fraction of the longest deferment time. In the previous example of a two-bit linear NAV, which divides the interval up into four equivalent pieces, a 1,0 field value indicated deferment for three quarters of the maximum length and that the electronic device should not transmit for that length of time. For the purposes of power saving, the same preamble NAV definition can be used, but in this case the 1,0 field value may indicate a maximum lower bound of the deferment time. In the downlink case, this indicates that the medium was reserved for between one half to three quarters of the interval length. Therefore, if the battery-powered electronic device wants to save power and to be sure of listening to every incoming frame, it could listen for a duration of one half of the maximum length.

In some embodiments, the access point reserves the medium and transmits frames in a long burst, but the frames transmitted may not be directed to the same client. In this case, the receiver in the battery-powered electronic device may not want to turn its receivers off for the entire reserved period, because one of the packets transmitted during the reserved period may be directed towards it. In order to address this challenge, a bit in the preamble may indicate whether all packets in this burst of packets are directed to the same client. If the electronic device receives a preamble in which the client identifier does not match its device identifier and the flag bit indicates that all the packets are for a single electronic device, the receiver can shut down for the entire deferment duration.

Moreover, in some embodiments the preamble includes a full or partial identifier for the access point as well as the client. This may help the client turn off more completely even if a particular burst of packets was not all directed towards the same user because, if they were not coming from the right transmitter, the client would not have to turn on to receive them. Furthermore, in the case of bursting packets to many different clients, the preamble NAV may only indicate the interval of time until the next packet with a different user.

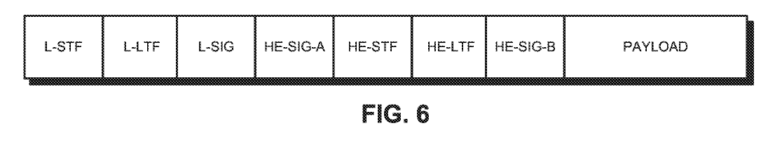

We now describe embodiments of the preamble format in a frame. FIG. 6 presents a drawing illustrating a frame format during communication among the electronic devices in FIG. 1 in accordance with some embodiments. In particular, the preamble may be included, at least in part, in the HE-SIG-A field. Note that in this configuration the identifier and/or the deferment duration time (which is sometimes referred to as the preamble NAV) is included in the frame prior to the information specifying the automatic-gain-control information and/or the modulation-and-coding information. In addition, the identifier and/or the deferment duration time may be included in a field that includes a checksum (such as a cyclic redundancy check), such as the SIG field.

Table 1 presents an embodiment of a preamble in a frame communicated among the electronic devices in FIG. 1 in accordance with some embodiments. In particular, Table 1 presents an example of the information included in the HE-SIG-A field.

TABLE 1

| CAT | SU | Proposed bits | Notes |
|---|---|---|---|
| SIGA format | Format indication | 1 | 0 if single user, 1 if |
| | | | multi-user |
| | Downlink/uplink flag | 1 | 0 if downlink, 1 if |
| | | | uplink |
| Spatial reuse fields | Basic service set color | 5 | Identifies the access |
| | | | point associated with |
| | | | a link |
| | Transmit opportunity | 9 | NAV/TXOP |
| | (TXOP) duration | | |
| Client identifier | AID/group identifier | 10 | Identifies the client or |
| | | | the group associated |
| | | | with a link |
| PLCP protocol data | Bandwidth | 2 | 20/40/80/160/80 + 80 |
| unit (PPDU) format | Payload guard interval | 2 | 0.8/1.6/3.2 μs |
| | Packet extension | 3 | — |
| Modulation and | MCS | 4 | MCS levels |
| coding scheme (MCS) | Coding | 1 | Binary convolutional |
| related | | | codes/low-density |
| | | | parity check |
| Multiple-input | Long-training-field | 1 | 2x/4x |
| multiple-output | compression | | |
| (MIMO) related | N streams | 3 | 1-8 |
| | Space-time block | 1 | — |
| | code | | |
| | Beamforming | 1 | — |
| Ending bits | Cyclic redundancy | 4 | — |
| | check | | |
| | Tail | 0 | Use tail-biting code |

In Table 1, the bits may use binary encoding. Moreover, when there are multiple transmissions to multiple users, these multiple users together may form a group and the access point may assign a group identifier to each such group of users. Furthermore, note that convolutional codes usually start by initializing the encoder to zeros (such as with six zeros) and ends with six zeros. This makes decoding easier, but the ease comes at the cost of adding six zeros at the end (which are sometimes referred to as ‘tail bits’). This additional overhead can be avoided doing tail biting, which essentially means initializing the encoder with six real payload bits that come at the end. While this introduces an additional operation in the decoding, it avoids the 12.5% overhead. Additionally, the physical portion of the Wi-Fi chip in the access point may perform the search. In particular, when the HE-SIG-A field is received, the access point knows the AID. Once the AID is known, the access point can look up the optimal receive antenna pattern corresponding to the client and can apply it to receiving the rest of the frame starting with the HE-STF field. For example, there may be a table in the Wi-Fi chip that stores the receive antenna pattern for each client (AID) associated to the access point.

While Table 1 presents a particular order to the preamble information in the HE-SIG-A field, in other embodiments a different ordering may be used. Moreover, the HE-SIG-A field may include more information, less information or different information than shown in Table 1.

While the preceding discussion illustrated the use of the communication technique during uplink communication between the transmitting electronic device and an access point, in other embodiments the communication technique is used during downlink communication between the access point and a receiving electronic device. For example, the communication technique can be used during downlink communication if there is more than one access point that can transmit to the receiving electronic device at any given time, and if the identifier in the MAC information field or MAC header includes the MAC address of the transmitting access point. Moreover, in some embodiments the communication technique is used with multiple potential transmitting electronic devices and a single receiving electronic device, e.g., in an ad-hoc network.

We now describe embodiments of an electronic device, such as access point 110 and/or one of electronic devices 112 in FIG. 1 that performs at least some of the operations in the communication technique. FIG. 7 presents a block diagram illustrating an electronic device 700 in accordance with some embodiments. This electronic device includes processing subsystem 710, memory subsystem 712, and networking subsystem 714. Processing subsystem 710 includes one or more devices configured to perform computational operations. For example, processing subsystem 710 can include one or more microprocessors, application-specific integrated circuits (ASICs), microcontrollers, programmable-logic devices, and/or one or more digital signal processors (DSPs).

Memory subsystem 712 includes one or more devices for storing data and/or instructions for processing subsystem 710 and networking subsystem 714. For example, memory subsystem 712 can include dynamic random access memory (DRAM), static random access memory (SRAM), and/or other types of memory. In some embodiments, instructions for processing subsystem 710 in memory subsystem 712 include: one or more program modules or sets of instructions (such as program module 722 or operating system 724), which may be executed by processing subsystem 710. Note that the one or more computer programs may constitute a computer-program mechanism. Moreover, instructions in the various modules in memory subsystem 712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 710.

In addition, memory subsystem 712 can include mechanisms for controlling access to the memory. In some embodiments, memory subsystem 712 includes a memory hierarchy that comprises one or more caches coupled to a memory in electronic device 700. In some of these embodiments, one or more of the caches is located in processing subsystem 710.

In some embodiments, memory subsystem 712 is coupled to one or more high-capacity mass-storage devices (not shown). For example, memory subsystem 712 can be coupled to a magnetic or optical drive, a solid-state drive, or another type of mass-storage device. In these embodiments, memory subsystem 712 can be used by electronic device 700 as fast-access storage for often-used data, while the mass-storage device is used to store less frequently used data.

Networking subsystem 714 includes one or more devices configured to couple to and communicate on a wired and/or wireless network (i.e., to perform network operations), including: control logic 716, an interface circuit 718 and one or more antennas 720 (or antenna elements). (While FIG. 7 includes one or more antennas 720, in some embodiments electronic device 700 includes one or more antenna nodes, such as nodes 708, e.g., a pad, which can be coupled to the one or more antennas 720. Thus, electronic device 700 may or may not include the one or more antennas 720.) For example, networking subsystem 714 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some embodiments, a receive antenna pattern or antenna radiation pattern of electronic device 700 may be adapted or changed using pattern shapers (such as reflectors) in one or more antennas 720 (or antenna elements), which can be independently and selectively electrically coupled to ground to steer the receive antenna radiation pattern in different directions. Thus, if one or more antennas 720 includes N antenna-radiation-pattern shapers, the one or more antennas 720 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 700 may use the mechanisms in networking subsystem 714 for performing simple wireless communication between the electronic devices, e.g., transmitting advertising or beacon frames and/or scanning for advertising frames transmitted by other electronic devices as described previously.

Within electronic device 700, processing subsystem 710, memory subsystem 712, and networking subsystem 714 are coupled together using bus 728. Bus 728 may include an electrical, optical, and/or electro-optical connection that the subsystems can use to communicate commands and data among one another. Although only one bus 728 is shown for clarity, different embodiments can include a different number or configuration of electrical, optical, and/or electro-optical connections among the subsystems.

In some embodiments, electronic device 700 includes a display subsystem 726 for displaying information on a display, which may include a display driver and the display, such as a liquid-crystal display, a multi-touch touchscreen, etc.

Electronic device 700 can be (or can be included in) any electronic device with at least one network interface. For example, electronic device 700 can be (or can be included in): a desktop computer, a laptop computer, a subnotebook/netbook, a server, a tablet computer, a smartphone, a cellular telephone, a consumer-electronic device, a portable computing device, an access point, a transceiver, a router, a switch, communication equipment, test equipment, and/or another electronic device.

Although specific components are used to describe electronic device 700, in alternative embodiments, different components and/or subsystems may be present in electronic device 700. For example, electronic device 700 may include one or more additional processing subsystems, memory subsystems, networking subsystems, and/or display subsystems. Additionally, one or more of the subsystems may not be present in electronic device 700. Moreover, in some embodiments, electronic device 700 may include one or more additional subsystems that are not shown in FIG. 7. Also, although separate subsystems are shown in FIG. 7, in some embodiments some or all of a given subsystem or component can be integrated into one or more of the other subsystems or component(s) in electronic device 700. For example, in some embodiments program module 722 is included in operating system 724 and/or control logic 716 is included in interface circuit 718.

Moreover, the circuits and components in electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 714. The integrated circuit may include hardware and/or software mechanisms that are used for transmitting wireless signals from electronic device 700 and receiving signals at electronic device 700 from other electronic devices. Aside from the mechanisms herein described, radios are generally known in the art and hence are not described in detail. In general, networking subsystem 714 and/or the integrated circuit can include any number of radios. Note that the radios in multiple-radio embodiments function in a similar way to the described single-radio embodiments.

In some embodiments, networking subsystem 714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques may be used. Thus, the communication technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program module 722, operating system 724 (such as a driver for interface circuit 718) or in firmware in interface circuit 718. Alternatively or additionally, at least some of the operations in the communication technique may be implemented in a physical layer, such as hardware in interface circuit 718.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An access point, comprising:
one or more antenna nodes configured to couple to an antenna; and
an interface circuit, coupled to the one or more antenna nodes, configured to communicate with a transmitting electronic device in a wireless local area network (WLAN), wherein the interface circuit is configured to:
receive, using a physical layer in the interface circuit, a preamble in a frame associated with the transmitting electronic device, wherein the preamble comprises an identifier of the transmitting electronic device, and wherein the preamble is received using an omnidirectional antenna pattern;
select, using the physical layer, a receive antenna pattern for the antenna based on the identifier of the transmitting electronic device; and
receive, using the physical layer, a payload in the frame, wherein the payload is received using the receive antenna pattern.

2. The access point of claim 1, wherein the identifier of the transmitting electronic device comprises a MAC address of the transmitting electronic device.

3. The access point of claim 1, wherein the identifier of the transmitting electronic device comprises one of: a partial identifier of the transmitting electronic device; and a full identifier of the transmitting electronic device.

4. The access point of claim 1, wherein the preamble comprises a deferment duration interval.

5. The access point of claim 4, wherein the deferment duration interval is encoded as a fraction of a maximum deferment time.

6. The access point of claim 4, wherein the deferment duration specifies a minimum upper bound on the deferment time.

7. The access point of claim 4, wherein the interface circuit is configured to transmit a broadcast message intended for one or more receiving electronic devices that specifies a maximum deferment duration interval.

8. The access point of claim 4, wherein the access point is configured to delay transmitting another frame based on the deferment duration interval to increase throughput in the WLAN.

9. A non-transitory computer-readable storage medium for use in conjunction with an access point, the computer-readable storage medium storing program instructions, wherein, when executed by the access point, the program instructions cause the access point to receive a payload by performing one or more operations comprising:
receiving, using a physical layer in the interface circuit, a preamble in a frame associated with a transmitting electronic device, wherein the preamble comprises an identifier of the transmitting electronic device, and wherein the preamble is received using an omnidirectional antenna pattern;
selecting, using the physical layer, a receive antenna pattern for the antenna based on the identifier of the transmitting electronic device; and
receiving, using the physical layer, the payload in the frame wherein the payload is received using the receive antenna pattern.

10. The computer-readable storage medium of claim 9, wherein the identifier of the transmitting electronic device comprises a MAC address of the transmitting electronic device.

11. The computer-readable storage medium of claim 9, wherein the identifier of the transmitting electronic device comprises one of: a partial identifier of the transmitting electronic device; and a full identifier of the transmitting electronic device.

12. The computer-readable storage medium of claim 9, wherein the preamble comprises a deferment duration interval.

13. The computer-readable storage medium of claim 12, wherein the deferment duration interval is encoded as a fraction of a maximum deferment time.

14. The computer-readable storage medium of claim 13, wherein the deferment duration specifies a minimum upper bound on the deferment time.

15. The computer-readable storage medium of claim 13, wherein the one or more operations comprise transmitting a broadcast message intended for one or more receiving electronic devices that specifies a maximum deferment duration interval.

16. The computer-readable storage medium of claim 13, wherein the one or more operations comprise delaying transmitting another frame based on the deferment duration interval to increase throughput in the WLAN.

17. A method for receiving a payload, wherein the method comprises:
receiving, using a physical layer in the interface circuit, a preamble in a frame associated with a transmitting electronic device, wherein the preamble comprises an identifier of the transmitting electronic device, and wherein the preamble is received using an omnidirectional antenna pattern;
selecting, using the physical layer, a receive antenna pattern for the antenna based on the identifier of the transmitting electronic device; and
receiving, using the physical layer, the payload in the frame, wherein the payload is received using the receive antenna pattern.

18. The method of claim 17, wherein the identifier of the transmitting electronic device comprises a MAC address of the transmitting electronic device.

19. The method of claim 17, wherein the identifier of the transmitting electronic device comprises one of: a partial identifier of the transmitting electronic device; and a full identifier of the transmitting electronic device.

20. The method of claim 17, wherein the preamble comprises a deferment duration interval.
